(19) United States
(12) Patent Application Publication
(10) Pub. No.: US 2015/0117468 A1
(43) Pub. Date: Apr. 30, 2015

(54) APPARATUS AND METHOD FOR TRANSMITTING DATA

(71) Applicant: Samsung SDS Co., Ltd., Seoul (KR)

(72) Inventors: Eung Seok SHIN, Seoul (KR); Young Ho JANG, Incheon (KR); Sung Hak SONG, Seongnam-si (KR)

(73) Assignee: Samsung SDS Co., Ltd., Seoul (KR)

(21) Appl. No.: 14/141,632

(22) Filed: Dec. 27, 2013

(30) Foreign Application Priority Data
Oct. 29, 2013 (KR) 10-2013-0129074

(51) Int. Cl. H04L 29/14; H04L 5/00

(52) U.S. Cl. CPC H04L 69/40; H04L 5/0055
USPC 370/474

(57) ABSTRACT

Provided are an apparatus and method for transmitting data. The apparatus for transmitting data comprises: a symbol encoder configured to generate a plurality of source symbols and at least one redundant symbol from data to be delivered, and to transmit the generated source symbols and the redundant symbol to a data receiving apparatus; a control message receiver configured to receive, from the data receiving apparatus, a control message indicating whether or not the plurality of source symbols and the redundant symbol are received; and a code rate controller configured to adjust, in accordance with the received control message, a code rate for generating the redundant symbol.

### CROSS-REFERENCE TO RELATED APPLICATION

This application claims priority to and the benefit of Republic of Korea Patent Application No. 10-2013-0129074 filed on Oct. 29, 2013, the disclosure of which is incorporated herein by reference in its entirety.

### BACKGROUND

1. Field

The present disclosure relates to technologies for data transmission on a network.

2. Discussion of Related Art

UDP (User Datagram Protocol) is a light-weight, simple-structured protocol as compared to TCP (Transmission Control Protocol) and, therefore, is widely used for data streaming, high-speed data transmission, or so on. The structural simplicity and light-weight of UDP would create a need for making up for some aspects, one of which relates to packet loss, whereas such need does not arise when TCP is used. This is because, for example, TCP itself includes a retransmission mechanism for a lost packet while UDP does not.

Instead of TCP, UDP is mainly used to meet hard real-time requirements for, e.g., data streaming, although there is a concern about such packet loss. According to TCP, however, a transmitter should wait for reception of a signal indicating that a certain transmitted packet has arrived at a receiver before the transmitter sends a next packet. This waiting process may take a considerable amount of time, thereby violating the real-time requirements for the data streaming.

As such, there is a need for providing a packet loss recovery scheme when a non-reliable protocol (for example, UDP) is used for transmission of data that have demanding real-time constraints.

### SUMMARY

Exemplary embodiments of the present disclosure are directed to providing means for ensuring the reliability of data in a data communication environment where a non-reliable protocol such as UDP is used.

According to an exemplary embodiment, there is an apparatus for transmitting data, comprising: a symbol encoder configured to generate a plurality of source symbols and at least one redundant symbol from data to be delivered, and to transmit the generated source symbols and the redundant symbol to a data receiving apparatus; a control message receiver configured to receive, from the data receiving apparatus, a control message indicating whether or not the plurality of source symbols and the redundant symbol are received; and a code rate controller configured to adjust, in accordance with the received control message, a code rate for generating the redundant symbol.

The code rate controller may adjust the code rate in accordance with a loss rate of the plurality of source symbols and the redundant symbol and a delay time between the data transmitting apparatus and the data receiving apparatus and wherein the loss rate of the plurality of source symbols and the redundant symbols, and the delay time may be determined from the received control message.

The code rate controller may adjust the code rate so that the code rate is decreased when the loss rate increases and the code rate is increased when the loss rate decreases.

The code rate controller may adjust the code rate so that the code rate is decreased when the delay time increases and the code rate is increased when the delay time decreases.

The control message may comprise at least one of a number of symbols received by the data receiving apparatus and lost symbol information.

The symbol encoder may retransmit, to the data receiving apparatus, at least one of the plurality of source symbols according to the lost symbol information included in the control message.

The code rate controller may comprise: a retransmission request rate calculator configured to calculate a retransmission request rate based on a delay time between the data transmitting apparatus and the data receiving apparatus, the delay time being calculated from the control message; a loss rate calculator configured to calculate a loss rate based on the number of received symbols, the number of received symbols being included in the control message; and a code rate calculator configured to calculate the code rate from the retransmission request rate and the loss rate.

The retransmission request rate calculator may adjust the retransmission request rate P_{Rdes} in real time so that an average network transmission delay time between the data transmitting apparatus and the data receiving apparatus approaches a predetermined maximum allowable value D_{des} without exceeding the maximum allowable value D_{des}.

The retransmission request rate may be calculated using the following equation:

$${P}_{{R}_{des}} \leq \frac{{D}_{des} - d}{{D}_{des} + d + \frac{I}{2}}$$

where P_{Rdes} is the retransmission request rate, D_{des} is the maximum allowable value of an average time taken for the respective symbols to be transmitted from the data transmitting apparatus to the data receiving apparatus, d is the delay time between the data transmitting apparatus and the data receiving apparatus, and I is a transmission period of the control message.

The loss rate may be calculated using the following equation:

Loss rate=1−(number of received symbols/number of transmitted symbols).

The code rate calculator may calculate the code rate so that a loss rate after the data receiving apparatus recovers a lost symbol approaches the retransmission request rate P_{Rdes}, calculated by the retransmission request rate calculator, without exceeding the retransmission request rate P_{Rdes}.

The symbol encoder may generate the source symbols and the redundant symbol using one of predetermined symbol encoding schemes having a code rate most similar to the calculated code rate.

The code rate may be calculated using the following equation:

$${P}_{Rdes} \geq \frac{{P}_{L} - 1 + \sqrt{{( 1 - {P}_{L} )}^{2} - 4 {CP}_{L} ( {( 1 - {P}_{L} )}^{\frac{C}{1 - C}} - 1 )}}{2}$$

where P_{Rdes} is the retransmission request rate, P_{L}, is the loss rate, and C is the code rate, and the symbol encoder may transmit the plurality of source symbols and the redundant symbol to the data receiving apparatus using user datagram protocol (UDP).

According to another exemplary embodiment, there is provided an apparatus for receiving data, comprising: a symbol decoder configured to receive, from a data transmitting apparatus, a plurality of source symbols and at least one redundant symbol, and to generate original data using the received source symbols and redundant symbol; a lost symbol extractor configured to determine whether or not there is a lost symbol using symbol information received by the symbol decoder, and to generate, when it is determined that there is the lost symbol, a lost symbol list including information regarding the lost symbol; and a control message transmitter configured to transmit, to the data transmitting apparatus, a control message including a number of symbols received by the symbol decoder and the lost symbol list.

When at least one of the source symbols is not received, the symbol decoder may recover the at least one of non-received source symbols using the redundant symbol.

The lost symbol may be a source symbol that is not recoverable using the redundant symbol, among the source symbols determined not to have been received by the symbol decoder.

The lost symbol extractor may determine whether or not there is the lost symbol using serial numbers of the received plurality of source symbols and the redundant symbol.

According to still another exemplary embodiment, there is provided a method of transmitting data, comprising: generating, at a symbol encoder, a plurality of source symbols and at least one redundant symbol from data to be delivered, and transmitting the generated source symbols and the redundant symbol to a data receiving apparatus; receiving, at a control message receiver, from the data receiving apparatus, a control message indicating whether or not the plurality of source symbols and the redundant symbol have been received; and adjusting, at a code rate controller, a code rate for generating the redundant symbol in accordance with the received control message.

The adjusting of the code rate may comprise adjusting the code rate in accordance with a loss rate of the plurality of source symbols and the redundant symbol and a delay time between a data transmitting apparatus and the data receiving apparatus.

The adjusting of the code rate may further comprise adjusting the code rate so that the code rate is decreased when the loss rate increases and the code rate is increased when the loss rate decreases.

The adjusting of the code rate may further comprise adjusting the code rate so that the code rate is decreased when the delay time increases and the code rate is increased when the delay time decreases.

The control message may comprise at least one of a number of symbols received by the data receiving apparatus and lost symbol information.

The method may further comprise retransmitting, at the symbol encoder, at least one of the plurality of source symbols to the data receiving apparatus according to the lost symbol information included in the control message.

The adjusting of the code rate may comprise: calculating a retransmission request rate based on a delay time between a data transmitting apparatus and the data receiving apparatus, the delay time being calculated from the control message; calculating a loss rate based on the number of received symbols, the number of received symbols being included in the control message; and calculating the code rate from the retransmission request rate and the loss rate.

The retransmission request rate may be calculated using the following equation:

$${P}_{{R}_{des}} \leq \frac{{D}_{des} - d}{{D}_{des} + d + \frac{I}{2}}$$

where P_{Rdes} is the retransmission request rate, D_{des} is a maximum allowable value of an average time taken for the respective symbols to be transmitted from the data transmitting apparatus to the data receiving apparatus, d is the delay time between the data transmitting apparatus and the data receiving apparatus, and I is a transmission period of the control message.

The loss rate may be calculated using the following equation:

Loss rate=1−(number of received symbols/number of transmitted symbols).

The code rate may be calculated using the following equation:

$${P}_{Rdes} \geq \frac{{P}_{L} - 1 + \sqrt{{( 1 - {P}_{L} )}^{2} - 4 {CP}_{L} ( {( 1 - {P}_{L} )}^{\frac{C}{1 - C}} - 1 )}}{2}$$

where P_{Rdes} is the retransmission request rate, P_{L} is the loss rate, and C is the code rate.

### BRIEF DESCRIPTION OF THE DRAWINGS

The above and other objects, features, and advantages of the present disclosure will become more apparent to those familiar with this field from the following detailed description when taken in conjunction with the accompanying drawings, in which:

FIG. 1 is a block diagram of a data delivery system according to an exemplary embodiment of the present disclosure;

FIG. 2 and FIG. 3 respectively illustrate an exemplary encoding process and an exemplary decoding process in a data delivery system using forward error correction (FEC) with a code rate of 3/4, according to exemplary embodiments of the present disclosure;

FIG. 4 is a detailed block diagram showing a transmitting terminal according to an exemplary embodiment of the present disclosure;

FIG. 5 is a detailed block diagram showing a receiving terminal according to an exemplary embodiment of the present disclosure;

FIG. 6 is a block diagram showing a structure of a symbol according to an exemplary embodiment of the present disclosure;

FIG. 7 is a block diagram showing a structure of a control message according to an exemplary embodiment of the present disclosure;

FIG. 8 is a flowchart illustrating a method of transmitting data according to an exemplary embodiment of the present disclosure;

FIG. 9 is a flowchart illustrating a process of determining, at a code rate calculator, a code rate according to an exemplary embodiment of the present disclosure;

FIG. 10 is a graph for showing a relationship between a loss rate and Equation 3, plotted for five different code rates of 1, 4/5, 3/4, 2/3, and 1/2;

FIG. 11 is an enlarged view of the lower section of the graph of FIG. 10; and

FIG. 12 is a flowchart illustrating a process of determining, at a retransmission request rate calculator, a retransmission request rate according to an exemplary embodiment of the present disclosure.

### DETAILED DESCRIPTION OF EXEMPLARY EMBODIMENTS

Exemplary embodiments of the present disclosure will be described below in more detail with reference to the accompanying drawings. However, the embodiments are merely examples and are not to be construed as limiting the present disclosure.

Various details already understood by those familiar with this field will be omitted to avoid obscuring the gist of the present disclosure. Terminology described below is defined considering functions in the present disclosure and may vary according to a user's or operator's intention or usual practice. Thus, the meanings of the terminology should be interpreted based on the overall context of the present specification. The terminology used in the description is intended to describe embodiments of the present disclosure only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

FIG. 1 is a block diagram of a data delivery system according to an exemplary embodiment of the present disclosure. As shown in FIG. 1, a data delivery system 100 in accordance with an exemplary embodiment of the present disclosure includes a transmitting terminal 102 and a receiving terminal 104.

The transmitting terminal 102 generates a plurality of symbols from data to be delivered, and transmits the generated symbols to the receiving terminal 104. These symbols include source symbols generated from the data to be delivered and a redundant symbol for use in recovering the source symbols. Also, the transmitting terminal 102 receives, from the receiving terminal 104, a control message including whether or not the transmitted symbols are received, and adjusts, based on the control message, a code rate for generating the symbols.

The receiving terminal 104 receives the plurality of symbols from the transmitting terminal 102, and decodes the received symbols to recover the data. Also, at a predetermined period, the receiving terminal 104 generates the control message including whether or not the symbols are received and provides the control message to the transmitting terminal 102.

Each of the transmitting terminal 102 and the receiving terminal 104 is a computing apparatus available on a network, and includes any kind of device capable of transmitting, receiving, and processing packet data on the network. In exemplary embodiments of the present disclosure, the network includes any kind of wired or wireless communication network through which data delivery can be performed between terminals, for example, a wired Internet network, a wireless Internet network, a mobile communication network, and so on.

Prior to a detailed explanation of the data delivery system 100 as mentioned above, forward error correction (FEC) will be discussed below. FEC is classified into various types in terms of its structure and functionality. According to a common type of FEC, the transmitting terminal 102 performs a process of encoding original data before transmitting the original data to the receiving terminal 104, and the receiving terminal 104 receives the encoded data and then performs a decoding process to recover the original data from the encoded data. When the original data remains unchanged during the encoding and decoding processes, such a type of FEC is referred to as being systematic, and otherwise is referred to as being non-systematic.

In exemplary embodiments of the present disclosure, the transmitting terminal 102 partitions the original data into a plurality of pieces. In an exemplary embodiment, the transmitting terminal 102 may transmit the original data using user datagram protocol (UDP), where such a piece may be a datagram, i.e., a unit of data transfer in UDP. In the following, each piece of the original data will be referred to as a source symbol.

A most typical and simplest way of implementing systematic FEC is to transmit a source symbol several times (redundant transmission scheme). By way of example, when there are given source symbols A, B, and C, the transmitting terminal 102 may transmit each symbol in a repeated fashion so that the transmitting terminal 102 transmits, for example, the symbols “A A B B C C.” In this case, the receiving terminal 104 can recover the original source symbols even if the receiving terminal 104 fails to receive either one of the repeated same source symbols transmitted for any original source symbol.

Another way of implementing systematic FEC is to generate a redundant symbol from two or more source symbols and then transmit the source symbols along with the redundant symbol (XOR scheme). In this scheme, XOR may be used for generating the redundant symbol. For example, when there are given source symbols A, B, and C, the redundant symbol generated from the source symbols may represent AxorBxorC (which, for the sake of convenience, will be referred to below as A+B+C). In this case, even if the receiving terminal 104 receives only three of the four symbols A, B, C, and A+B+C, the receiving terminal 104 can recover the other, non-received symbol.

According to non-systematic FEC, original source symbols are encoded into different symbols, which do not include any one of the original source symbols, and such different symbols are transmitted. For example, when there are given source symbols A, B, and C, the transmitting terminal 102 encodes the source symbols to generate symbols D, E, F, G, and H, each of which is different from any one of the original source symbols, and transmits the generated symbols to the receiving terminal 104. Then, the receiving terminal 104 decodes the received symbols D, E, F, G, and H to recover the original symbols A, B, and C. Examples of non-systematic FEC may include fountain codes such as a Luby-Transform (LT) code, a Raptor code and so on.

Neither of the encoding process of systematic FEC and that of non-systematic FEC demands a large amount of resources. However, the decoding process of non-systematic FEC involves a more complicated calculation than that of systematic FEC, and, accordingly, demands a larger amount of central processing unit (CPU) and memory usage.

In exemplary embodiments of the present disclosure, the transmitting terminal 102 and the receiving terminal 104 are configured to apply a systematic FEC scheme, intended for use in conjunction with automatic repeat request (ARQ), to perform data delivery. This is because when a symbol to be retransmitted is determined for an ARQ procedure, such a systematic FEC scheme allows a direct request for the to-be-retransmitted symbol without another encoding/decoding process, whereas a non-systematic FEC scheme requires an additional algorithm to determine the to-be-retransmitted symbol.

Meanwhile, according to the redundant transmission scheme mentioned above with respect to systematic FEC implementations, a redundancy rate cannot be less than 50%. A redundancy rate denotes a ratio of the number of redundant symbols to the number of all transmitted symbols). This is because in the redundant transmission scheme, each symbol should be transmitted at least twice. In other words, the redundant transmission scheme would likely cause an excessive waste of a bandwidth if a packet loss rate is low. On the other hand, the XOR scheme cannot have a redundancy rate increased to 50% or more. Thus, exemplary embodiments of the present disclosure allow for network conditions to use the two schemes in an eclectic manner.

In accordance with the XOR scheme, some of symbols are regarded to constitute a single set. By way of example, for symbols A, B, C, A+B+C, D, E, F, and D+E+F, the symbols A, B, C, and A+B+C constitute a set, and the symbols D, E, F, and D+E+F constitute another set. Each of these sets is referred to as a sequence. In other words, when such a sequence consists of n symbols, the n symbols include n−1 source symbols and one redundant symbol.

In exemplary embodiments of the present disclosure, the number of symbols included in a sequence varies according to a code rate of FEC coding. For exemplary embodiments of the present disclosure, such a code rate is represented in the form of a fraction “(N−1)/N” (where N is a natural number greater than or equal to two). For example, when the code rate is 3/4, the sequence includes three original source symbols A, B, and C, and one redundant symbol (A+B+C). The code rate of 1, however, indicates that no XOR-based FEC is used.

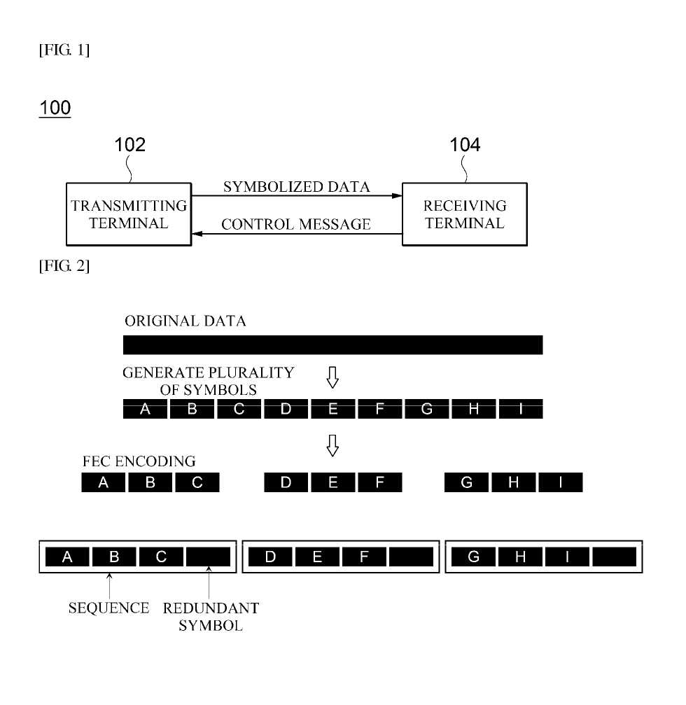

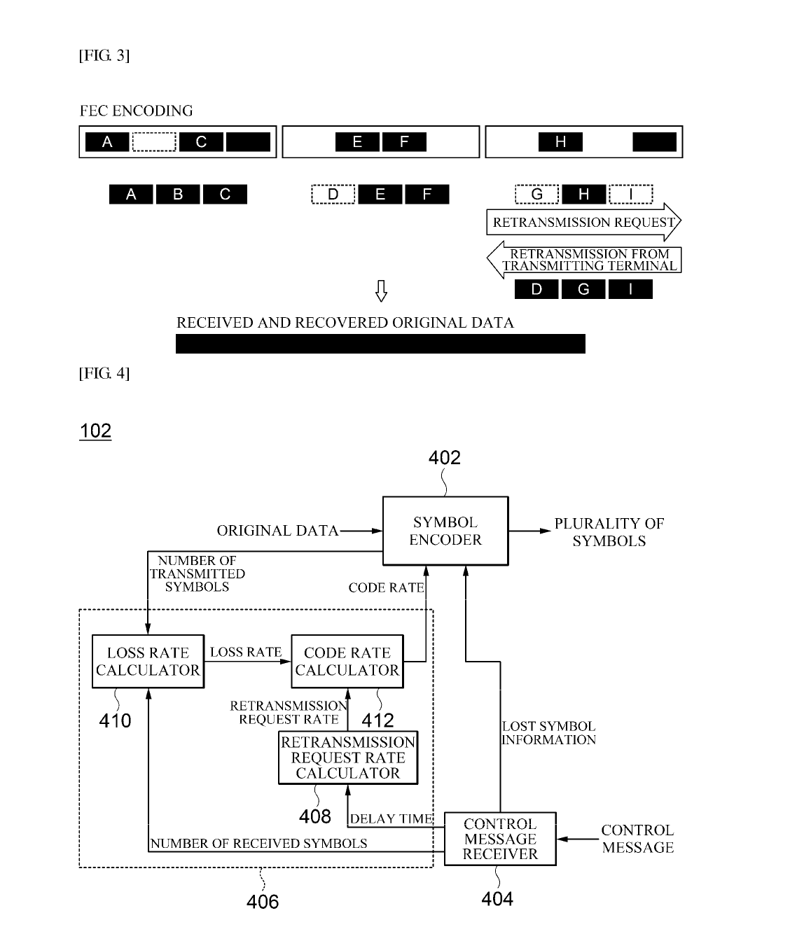

FIG. 2 and FIG. 3 respectively illustrate an exemplary encoding process and an exemplary decoding process using FEC with a code rate of 3/4.

First, as shown in FIG. 2, the transmitting terminal 102 generates a plurality of symbols by partitioning to-be-transmitted data into suitably sized pieces, performs an FEC encoding process on the symbols, and transmits the encoded symbols to the receiving terminal 104. As mentioned above, a group of some encoded symbols may be referred to as a sequence.

Some of the symbols transmitted from the transmitting terminal 102 may not arrive at the receiving terminal 104 (i.e., may be lost) for various reasons such as a network error, an application error, and so on. When some of the transmitted symbols are lost, the receiving terminal 104 may recover the lost symbols through an XOR operation using a redundant symbol.

For example, when only B is lost in a sequence consisting of A, B, C, and A+B+C as shown on the left side of FIG. 3, the receiving terminal 104 may recover B by performing an XOR operation on the received symbols A, C, and A+B+C. However, when two or more of the symbols in a single sequence are lost as shown on the middle or the right side of FIG. 3, the receiving terminal 104 cannot recover the lost symbols from the received symbols. Accordingly, the receiving terminal 104 requests retransmission of the lost symbols from the transmitting terminal 102, and the transmitting terminal 102 retransmits the requested symbols. In the illustrated example, the lost symbols D, G, and I are retransmitted. It is not necessary to retransmit the symbol D+E+F, which is a redundant symbol, even when the symbol is lost. The receiving terminal 104 requests retransmission of the lost symbols from the transmitting terminal 102 at predetermined periods, and the transmitting terminal 102 retransmits the requested symbols to the receiving terminal 104 immediately after receiving such request. This series of transmission and reception processes is performed according to a non-reliable protocol such as UDP, and the receiving terminal 104 repeatedly requests retransmission until all of the lost symbols arrive thereat.

Meanwhile, in exemplary embodiments of the present disclosure, the transmitting terminal 102 and the receiving terminal 104 may include a same type of network device and merely perform different functions. For example, when two terminal exchange data with each other on a network, a terminal transmitting data at a certain time point may be referred to as the transmitting terminal 102 in accordance with an exemplary embodiment of the present disclosure, and a terminal receiving the data may be referred to as the receiving terminal 104. In other words, a terminal may be referred to as the transmitting terminal 102 or as the receiving terminal 104, in terms of the functions the terminal performs. Further, one of two terminals for unidirectional communications has the functions of the transmitting terminal 102 and the other terminal has the functions of the receiving terminal 104, while each of two terminals for bidirectional communications has the functions of the transmitting terminal 102 and those of the receiving terminal 104.

FIG. 4 is a detailed block diagram showing a transmitting terminal according to an exemplary embodiment of the present disclosure. As shown in FIG. 4, the transmitting terminal 102 according to an exemplary embodiment of the present disclosure includes a symbol encoder 402, a control message receiver 404, and a code rate controller 406.

The symbol encoder 402 generates a plurality of source symbols and at least one redundant symbol from data to be delivered, and transmits the generated source symbols and redundant symbol to the receiving terminal 104. Further, the symbol encoder 402 receives lost symbol information from the control message receiver 404, and retransmits a lost symbol to the receiving terminal 104 according to the lost symbol information. The symbol encoder 402 may further include a transmitted symbol buffer (not shown). The transmitted symbol buffer is a storage for temporarily storing symbols transmitted to the receiving terminal 104. The symbol encoder 402 temporarily stores the transmitted symbols in the transmitted symbol buffer, and deletes the symbols when the transmission thereof to the receiving terminal 104 is completed. Based on a control message received from the receiving terminal 104, it can be recognized whether or not the transmission of each symbol has been completed.

Furthermore, as mentioned above, the symbol encoder 402 may transmit the source symbols and the redundant symbol to the receiving terminal 104 using a non-reliable protocol such as UDP. In this case, the symbol encoder 402 may configure each datagram to include one symbol.

The control message receiver 404 receives a control message from the receiving terminal 104. The control message includes at least one of the number of symbols received by the receiving terminal 104 and information regarding a lost symbol. The number of received symbols is delivered to the code rate controller 406, and the lost symbol information is delivered to the symbol encoder 402. A detailed constitution of the control message will be described later.

In accordance with the control message received by the control message receiver 404, the code rate controller 406 controls a code rate for generating the redundant symbol. The code rate controller 406 may adjust the code rate based on a loss rate of the source symbols and the redundant symbol transmitted from the symbol encoder 402 and a delay time between the transmitting terminal 102 and the receiving terminal 104. Specifically, the code rate controller 406 may adjust the code rate so that the code rate is decreased when the loss rate is increased the code rate is increased when the loss rate is decreased. Further, the code rate controller 406 may adjust the code rate so that the code rate is decreased when the delay time is increased and the code rate is increased when the delay time is decreased.

The code rate controller 406 may include a retransmission request rate calculator 408, a loss rate calculator 410, and a code rate calculator 412.

The retransmission request rate calculator 408 calculates a retransmission request rate according to the delay time between the transmitting terminal 102 and the receiving terminal 104, where the delay time is calculated from the control message received by the control message receiver 404. The retransmission request rate may be calculated using, for example, Equation 1 below:

$${P}_{{R}_{des}} \leq \frac{{D}_{des} - d}{{D}_{des} + d + \frac{I}{2}}$$

where P_{Rdes} is the retransmission request rate, D_{des} is the maximum allowable value of an average time required for the respective symbols to be transmitted from the transmitting terminal 102 to the receiving terminal 104, d is the delay time between the transmitting terminal 102 and the receiving terminal 104, and I is a transmission period of the control message. The delay time may be a round trip time (RTT) between the transmitting terminal 102 and the receiving terminal 104. As can be seen from Equation 1 above, as D_{des} becomes smaller (i.e., the transmission of each symbol should be completed more rapidly), the retransmission request rate becomes smaller and the code rate is selected as a small value as well. If D_{des} is large, sufficient time is allowed for the symbol transmissions and, therefore, the retransmission request rate is increased and the code rate is also increased so that the bandwidth waste may be reduced. In other words, for the network transmission delay time d, fixed or varying, between the transmitting terminal 102 and the receiving terminal 104, the retransmission request rate calculator 408 adjusts the retransmission request rate P_{Rdes} in real time so that an average network transmission delay time (a value calculated using d, P_{Rdes}, and I) of transmitted data approaches the predetermined maximum allowable value D_{des} without exceeding the maximum allowable value D_{des}.

The loss rate calculator 410 calculates a loss rate according to the number of received symbols included in the control message. The loss rate may be calculated using, for example, Equation 2 below. The number of transmitted symbols may be obtained from the symbol encoder 402.

Loss rate=1−(number of received symbols/number of transmitted symbols). [Equation 2]

To improve the accuracy in the loss rate calculation, the loss rate calculator 410 may use time group information given to each symbol. For example, the symbol encoder 402 may divide the generated symbols into a plurality of time groups according to their transmission times, and each symbol includes information regarding a time group to which the symbol belongs. Using the time group information, the receiving terminal 104 may incorporate, into the control message, the number of received symbols in each time group to transmit the control message to the transmitting terminal 102, and the loss rate calculator 410 may calculate a loss rate for each time group using the number. When each symbol is given a time group in this manner, an accurate loss rate can be calculated even if the number of transmitted symbols varies over time or a communication delay occurs between the transmitting terminal 102 and the receiving terminal 104.

The code rate calculator 412 calculates the code rate from the retransmission request rate and the loss rate. The code rate may be calculated using, for example, Equation 3 below.

$${P}_{Rdes} \geq \frac{{P}_{L} - 1 + \sqrt{{( 1 - {P}_{L} )}^{2} - 4 {CP}_{L} ( {( 1 - {P}_{L} )}^{\frac{C}{1 - C}} - 1 )}}{2}$$

where P_{Rdes} is the retransmission request rate, P_{L} is the loss rate, and C is the code rate.

The code rate calculator 412 may select, from among the code rates determined for use in the data transmission, the largest code rate which satisfies Equation 3. Specifically, for the fixed or varying loss rate P_{L} of the network, the code rate calculator 412 may determine the code rate C so that a loss rate after the receiving terminal 104 recovers as many recoverable lost symbols as possible approaches the retransmission request rate P_{Rdes}, calculated by the retransmission request rate calculator 408, without exceeding the retransmission request rate P_{Rdes}. Then, the symbol encoder 402 may generate the source symbols and the redundant symbol using one of predetermined symbol encoding schemes which has a code rate most similar to the determined code rate (in other words, the largest code rate within a range of calculated values of C).

To find an appropriate code rate from Equation 3 above, a process of rearranging the equation with respect to the code rate C is necessary. However, it is very difficult to algebraically rearrange Equation 3 due to its characteristics, and even when Equation 3 can be algebraically rearranged, a considerable amount of calculations is required for applying same to an actual calculation of the code rate. Thus, it is practically efficient to determine code rates for use in data transmission in advance, and use a table in which the threshold value of the loss rate for each code rate is included after being calculated using Equation 3 above.

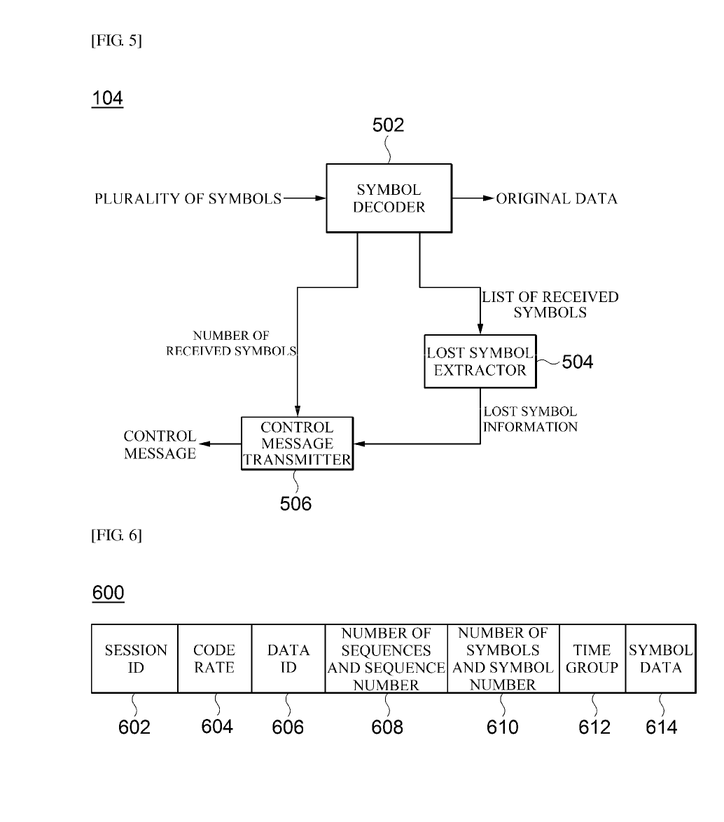

FIG. 5 is a detailed block diagram showing a receiving terminal according to an exemplary embodiment of the present disclosure. As shown in FIG. 5, the receiving terminal 104 according to an exemplary embodiment of the present disclosure includes a symbol decoder 502, a lost symbol extractor 504, and a control message transmitter 506.

The symbol decoder 502 receives a plurality of source symbols and at least one redundant symbol from the transmitting terminal 102, and recovers the original data using the received source symbols and redundant symbol. Further, when some of the source symbols are not received, the symbol decoder 502 may recover the non-received source symbols using the redundant symbol. Like the symbol encoder 402, the symbol decoder 502 may include a received symbol buffer (not shown). The symbol decoder 502 stores, on a per-sequence basis, the received symbols in the received symbol buffer and deletes, from the buffer, the symbols in a sequence when the reception of the symbols in the sequence is completed.

The lost symbol extractor 504 determines whether or not there is a lost symbol using symbol information received by the symbol decoder 502, and when it is determined that there is a lost symbol, generates a lost symbol list including information regarding the lost symbol. The lost symbol may be a source symbol that is not recoverable using the redundant symbol among the source symbols determined not to have been received by the symbol decoder 502. Basically, the redundant symbol is not regarded as a lost symbol since it is unnecessary to retransmit the redundant symbol even when the redundant symbol is not received.

The lost symbol extractor 504 may determine whether or not there is a lost symbol using serial numbers of the respective received symbols. For example, when the symbol having a serial number “102” is received and then the symbol having a serial number “104” is received, the lost symbol extractor 504 may determine that the symbol having a serial number “103” has been lost in the interim.

The control message transmitter 506 transmits a control message including the number of symbols received by the symbol decoder 502 for a predetermined time interval and the lost symbol list to the transmitting terminal 102. The control message may be transmitted to the transmitting terminal 102 at predetermined periods.

FIG. 6 is a block diagram showing a structure of a symbol according to an exemplary embodiment of the present disclosure. As shown in FIG. 6, a symbol 600 according to an exemplary embodiment of the present disclosure includes a session identity (ID) 602, a code rate 604, a data ID 606, a number of sequences and a sequence number 608, a number of symbols and a symbol number 610, a time group 612, and symbol data 614.

The session ID 602 is identification information for identifying the transmitting terminal 102 that has transmitted the symbol 600. This is used to identify respective terminals when the respective terminals communicate in a one-to-many fashion.

The code rate 604 denotes a code rate applied to the symbol 600. In exemplary embodiments of the present disclosure, different code rates may be given to respective sequences.

The data ID 606 is identification information regarding original data corresponding to the symbol 600.

The number of sequences and sequence number 608 denote the total number of sequences included in the original data and a serial number of a sequence including the symbol 600.

The number of symbols and symbol number 610 denote the total number of symbols included in the sequence and the serial number for identifying the respective symbol.

The time group 612 is information regarding a time group to which the symbol 600 belongs. As described above, the time group information is used for calculating a loss rate.

The symbol data 614 is content of the symbol 600.

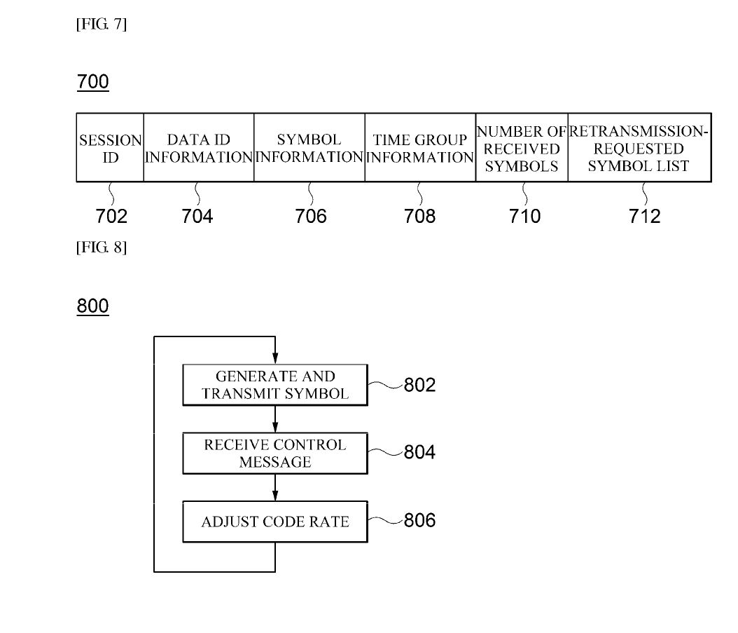

FIG. 7 is a block diagram showing a structure of a control message according to an exemplary embodiment of the present disclosure. As shown in the FIG. 7, a control message 700 according to an exemplary embodiment of the present disclosure includes a session ID 702, data ID information 704, symbol information 706, time group information 708, a number of received symbols 710, and a retransmission-requested symbol list 712.

The session ID 702 is identification information for identifying the receiving terminal 104 that transmits the control message 700.

The data ID information 704 is identification information regarding the original data corresponding to a received symbol.

The symbol information 706 is information regarding the latest of the symbols received up to the current time by the receiving terminal 104. For example, a serial number of the latest symbol may be stored as the symbol information 706.

The time group information 708 is information regarding a time group to which the latest symbol belongs.

The number of received symbols 710 is information regarding how many symbols have been received in a specific time group.

The retransmission-requested symbol list 712 denotes a list of symbols determined, at the receiving terminal 104, to be lost.

FIG. 8 is a flowchart illustrating a method of transmitting data according to an exemplary embodiment of the present disclosure. The method illustrated in FIG. 8 may be performed by, for example, the above-mentioned transmitting terminal 102. Although the method is illustrated in the flowchart as including a plurality of steps, at least some of the steps may be performed in a different order, performed in combination with another step, omitted, subdivided, or performed together with at least one step which is not shown therein.

In step 802, the symbol encoder 402 generates a plurality of source symbols and at least one redundant symbol from data to be delivered, and transmits the generated source symbols and redundant symbol to the receiving terminal 104.

In step 804, the control message receiver 404 receives, from the receiving terminal 104, a control message including whether or not the source symbols and the redundant symbol have been received. The control message includes at least one of the number of symbols received by the receiving terminal 104 and lost symbol information.

In step 806, the code rate controller 406 adjusts, according to the control message received in step 804, a code rate for generating the redundant symbol. In step 806, the code rate may be adjusted according to a loss rate of the source symbols and the redundant symbol transmitted from the symbol encoder 402 and a delay time between the transmitting terminal 102 and the receiving terminal 104.

Specifically, step 806 may include a sub-step in which the retransmission request rate calculator 408 calculates a retransmission request rate according to the delay time between the transmitting terminal 102 and the receiving terminal 104, where the delay time is calculated from the control message, a sub-step in which the loss rate calculator 410 calculates a loss rate according to the number of received symbols included in the control message, and a sub-step in which the code rate calculator 412 calculates the code rate from the retransmission request rate and the loss rate.

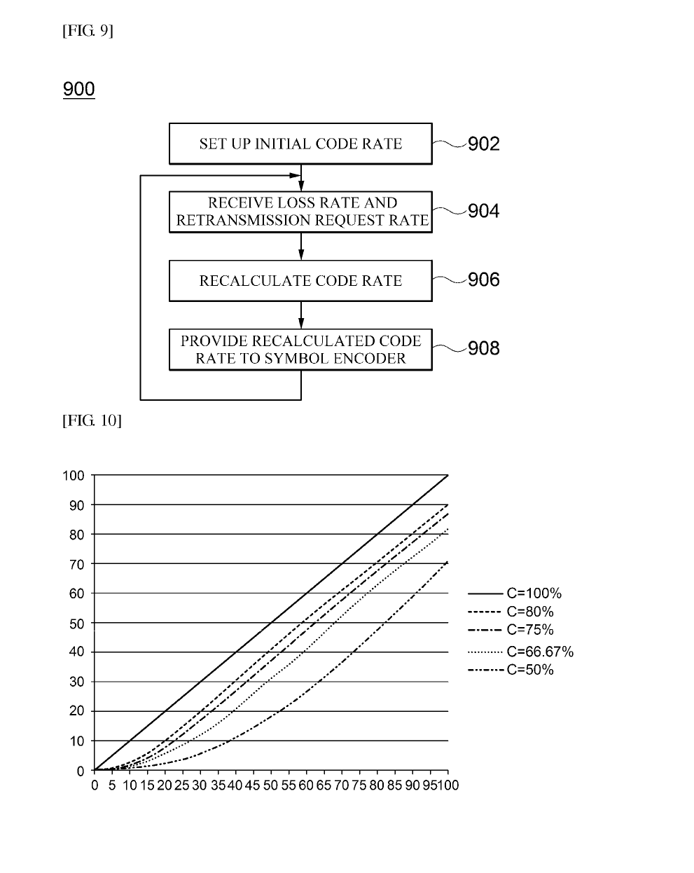

FIG. 9 is a flowchart illustrating a process of determining, at a code rate calculator, a code rate according to an exemplary embodiment of the present disclosure.

In step 902, the code rate calculator 412 determines code rates for use in a data transmission/reception process between the transmitting terminal 102 and the receiving terminal 104, and determines, from the code rates, an initial code rate for use in an initial data transmission/reception. For example, the code rate calculator 412 may determine five code rates of 1/2 (=50%), 2/3 (=66.67%), 3/4 (=75%), 4/5 (=80%), and 1 (=100%) for use in data transmissions, and determine the code rate of 3/4 among the code rates as an initial code rate. The code rates may have been set in the code rate calculator 412 in advance.

In step 904, the code rate calculator 412 receives a loss rate and a retransmission request rate from the loss rate calculator 410 and the retransmission request rate calculator 408, respectively.

In step 906, the code rate calculator 412 recalculates a code rate according to the received loss rate and retransmission request rate.

In step 908, the code rate calculator 412 provides the recalculated code rate to the symbol encoder 402, thereby enabling the symbol encoder 402 to encode data using the recalculated code rate. Step 904 to step 908 may be repeatedly performed whenever a control message is received from the receiving terminal 104 and the loss rate and the retransmission request rate are updated.

As described above, in order to rapidly transmit data in real time, it is necessary to reduce an ARQ-based correction rate and increase an FEC-based correction rate as much as possible. However, when a code rate is blindly lowered to reduce an ARQ-based correction rate, an excessive number of redundant symbols may cause a waste of a network bandwidth as well as a loss in transmission efficiency in a high-quality network environment. Thus, exemplary embodiments of the present disclosure are configured to adjust a code rate appropriate for conditions of a network environment while keeping an ARQ-based correction rate at a predetermined level or less through the code rate adjustment as described above.

Meanwhile, the recalculation of the code rate as illustrated in step 906 is performed according to Equation 3 above. In other words, the code rate calculator 412 selects the largest code rate which satisfies Equation 3 from among predetermined code rates (in the above-described example, the five code rates of 1, 4/5, 3/4, 2/3, and 1/2)

FIG. 10 is a graph for showing a relationship between a loss rate and Equation 3, plotted for five different code rates of 1, 4/5, 3/4, 2/3, and 1/2. In FIG. 10, the x-axis denotes the loss rate P_{L}, the y-axis denotes the retransmission request rate P_{Rdes}, and each of the five plots in the x-y plane denotes the value of the right-hand side of Equation 3 for a respective one of the above-mentioned code rates. In addition, FIG. 11 is an enlarged view of the lower section of the graph of FIG. 10. For example, it is assumed that the retransmission request rate calculated by the retransmission request rate calculator 408 is 2%. To keep the retransmission request rate at 2% or less, a code rate should be selected so that a curve is located under the 2% line within a range of calculated loss rates. For example, according to the illustrated graph, the code rate is 1 when the loss rate is 2% or less, and the code rate is 4/5 when the loss rate is greater than or equal to 2% and less than 7.5% (see thick lines indicated in FIG. 11).

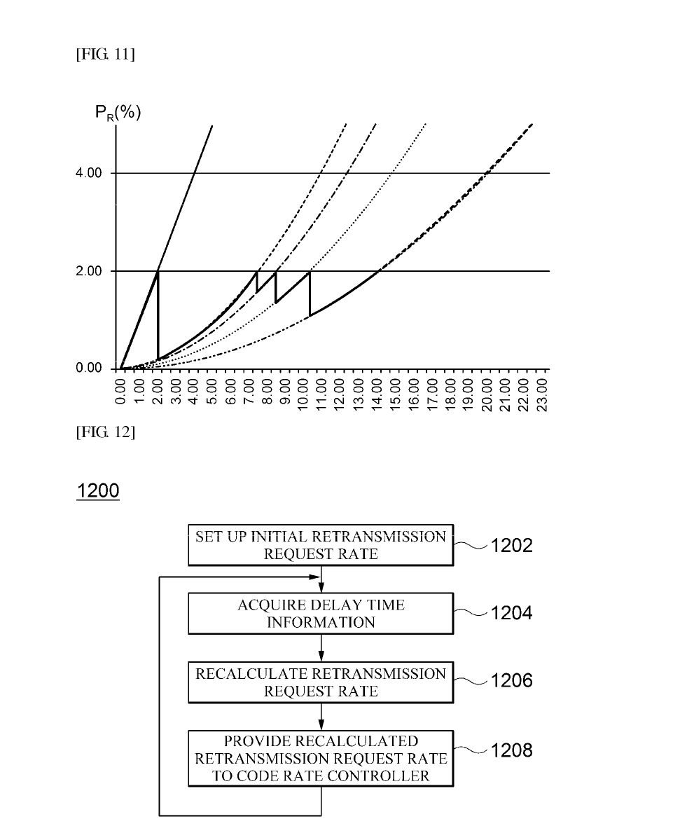

FIG. 12 is a flowchart illustrating a process of determining, at a retransmission request rate calculator, a retransmission request rate according to an exemplary embodiment of the present disclosure.

In step 1202, the retransmission request rate calculator 408 sets up an arbitrary initial retransmission request rate.

In step 1204, the retransmission request rate calculator 408 acquires a delay time between the transmitting terminal 102 and the receiving terminal 104. As mentioned above, the delay time may be, for example, an RTT between the transmitting terminal 102 and the receiving terminal 104 or so on.

In step 1206, the retransmission request rate calculator 408 recalculates a retransmission request rate using the delay time information. The retransmission request rate may be calculated using, for example, Equation 1 described above.

In step 1208, the retransmission request rate calculator 408 provides the recalculated retransmission request rate to the code rate calculator 412. Step 1204 to step 1208 may be repeatedly performed whenever a control message is received from the receiving terminal 104.

Meanwhile, exemplary embodiments of the present disclosure may include a computer-readable recording medium including a program for performing the methods described in the present specification in a computer. The computer-readable recording medium may include program instructions, local data files, and local data structures, alone or in combination. The medium may be specially designed and configured for the present disclosure, or well known and available to those skilled in the field of computer software. Examples of the computer-readable recording medium include magnetic media such as a hard disk, a floppy disk and a magnetic tape, optical recording media such as a CD-ROM and a DVD, a magneto-optical medium such as a floptical disk, and hardware devices, specially configured to store and execute program instructions, such as a ROM, a RAM, and a flash memory. Examples of the program instructions may include high-level language codes executable by a computer using an interpreter or the like, as well as machine language codes made by a compiler.

According to exemplary embodiments of the present disclosure, in a data delivery environment employing a non-reliable protocol such as UDP, it is possible to ensure both the reliability and real-time characteristic of data transmission using ARQ and FEC together.

In addition, according to exemplary embodiments of the present disclosure, it is possible to effectively use a network bandwidth by adaptively adjusting a code rate of FEC in consideration of a transmission delay time and a packet loss rate between a transmitter side and a receiver side.

It will be apparent to those familiar with this field that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. An apparatus for transmitting data, comprising:
a symbol encoder configured to generate a plurality of source symbols and at least one redundant symbol from data to be delivered, and to transmit the generated source symbols and the redundant symbol to a data receiving apparatus;
a control message receiver configured to receive, from the data receiving apparatus, a control message indicating whether or not the plurality of source symbols and the redundant symbol are received; and
a code rate controller configured to adjust, in accordance with the received control message, a code rate for generating the redundant symbol.

2. The apparatus of claim 1, wherein the code rate controller adjusts the code rate in accordance with a loss rate of the plurality of source symbols and the redundant symbol and a delay time between the data transmitting apparatus and the data receiving apparatus and wherein the loss rate of the plurality of source symbols and the redundant symbols, and the delay time are determined from the received control message.

3. The apparatus of claim 2, wherein the code rate controller adjusts the code rate so that the code rate is decreased when the loss rate increases and the code rate is increased when the loss rate decreases.

4. The apparatus of claim 2, wherein the code rate controller adjusts the code rate so that the code rate is decreased when the delay time increases and the code rate is increased when the delay time decreases.

5. The apparatus of claim 1, wherein the control message comprises at least one of a number of symbols received by the data receiving apparatus and lost symbol information.

6. The apparatus of claim 5, wherein the symbol encoder retransmits, to the data receiving apparatus, at least one of the plurality of source symbols according to the lost symbol information included in the control message.

7. The apparatus of claim 5, wherein the code rate controller comprises:
a retransmission request rate calculator configured to calculate a retransmission request rate based on a delay time between the data transmitting apparatus and the data receiving apparatus, the delay time being calculated from the control message;
a loss rate calculator configured to calculate a loss rate based on the number of received symbols, the number of received symbols being included in the control message; and
a code rate calculator configured to calculate the code rate from the retransmission request rate and the loss rate.

8. The apparatus of claim 7, wherein the retransmission request rate calculator adjusts the retransmission request rate P_{Rdes} in real time so that an average network transmission delay time between the data transmitting apparatus and the data receiving apparatus approaches a predetermined maximum allowable value D_{des} without exceeding the maximum allowable value D_{des}.

9. The apparatus of claim 8, wherein the retransmission request rate is calculated using the following equation:
$${P}_{{R}_{des}} \leq \frac{{D}_{des} - d}{{D}_{des} + d + \frac{I}{2}}$$
where P_{Rdes} is the retransmission request rate, D_{des} is the maximum allowable value of an average time taken for the respective symbols to be transmitted from the data transmitting apparatus to the data receiving apparatus, d is the delay time between the data transmitting apparatus and the data receiving apparatus, and I is a transmission period of the control message.

10. The apparatus of claim 7, wherein the loss rate is calculated using the following equation:
Loss rate=1−(number of received symbols/number of transmitted symbols).

11. The apparatus of claim 7, wherein the code rate calculator calculates the code rate so that a loss rate after the data receiving apparatus recovers a lost symbol approaches the retransmission request rate P_{Rdes}, calculated by the retransmission request rate calculator, without exceeding the retransmission request rate P_{Rdes}, and
the symbol encoder generates the source symbols and the redundant symbol using one of predetermined symbol encoding schemes having a code rate most similar to the calculated code rate.

12. The apparatus of claim 11, wherein the code rate is calculated using the following equation:
$${P}_{Rdes} \geq \frac{{P}_{L} - 1 + \sqrt{{( 1 - {P}_{L} )}^{2} - 4 {CP}_{L} ( {( 1 - {P}_{L} )}^{\frac{C}{1 - C}} - 1 )}}{2}$$
where P_{Rdes} is the retransmission request rate, P_{L}, is the loss rate, and C is the code rate.

13. The apparatus of claim 1, wherein the symbol encoder transmits the plurality of source symbols and the redundant symbol to the data receiving apparatus using user datagram protocol (UDP).

14. An apparatus for receiving data, comprising:
a symbol decoder configured to receive, from a data transmitting apparatus, a plurality of source symbols and at least one redundant symbol, and to generate original data using the received source symbols and redundant symbol;
a lost symbol extractor configured to determine whether or not there is a lost symbol using symbol information received by the symbol decoder, and to generate, when it is determined that there is the lost symbol, a lost symbol list including information regarding the lost symbol; and
a control message transmitter configured to transmit, to the data transmitting apparatus, a control message including a number of symbols received by the symbol decoder and the lost symbol list.

15. The apparatus of claim 14, wherein, when at least one of the source symbols is not received, the symbol decoder recovers the at least one of non-received source symbols using the redundant symbol.

16. The apparatus of claim 15, wherein the lost symbol is a source symbol that is not recoverable using the redundant symbol, among the source symbols determined not to have been received by the symbol decoder.

17. The apparatus of claim 14, wherein the lost symbol extractor determines whether or not there is the lost symbol using serial numbers of the received plurality of source symbols and the redundant symbol.

18. A method of transmitting data, comprising:
generating, at a symbol encoder, a plurality of source symbols and at least one redundant symbol from data to be delivered, and transmitting the generated source symbols and the redundant symbol to a data receiving apparatus;
receiving, at a control message receiver, from the data receiving apparatus, a control message indicating whether or not the plurality of source symbols and the redundant symbol have been received; and
adjusting, at a code rate controller, a code rate for generating the redundant symbol in accordance with the received control message.

19. The method of claim 18, wherein the adjusting of the code rate comprises adjusting the code rate in accordance with a loss rate of the plurality of source symbols and the redundant symbol and a delay time between a data transmitting apparatus and the data receiving apparatus.

20. The method of claim 19, wherein the adjusting of the code rate further comprises adjusting the code rate so that the code rate is decreased when the loss rate increases and the code rate is increased when the loss rate decreases.

21. The method of claim 19, wherein the adjusting of the code rate further comprises adjusting the code rate so that the code rate is decreased when the delay time increases and the code rate is increased when the delay time decreases.

22. The method of claim 18, wherein the control message comprises at least one of a number of symbols received by the data receiving apparatus and lost symbol information.

23. The method of claim 22, further comprising retransmitting, at the symbol encoder, at least one of the plurality of source symbols to the data receiving apparatus according to the lost symbol information included in the control message.

24. The method of claim 22, wherein the adjusting of the code rate comprises:
calculating a retransmission request rate based on a delay time between a data transmitting apparatus and the data receiving apparatus, the delay time being calculated from the control message;
calculating a loss rate based on the number of received symbols, the number of received symbols being included in the control message; and
calculating the code rate from the retransmission request rate and the loss rate.

25. The method of claim 24, wherein the retransmission request rate is calculated using the following equation:
$${P}_{{R}_{des}} \leq \frac{{D}_{des} - d}{{D}_{des} + d + \frac{I}{2}}$$
where P_{Rdes} is the retransmission request rate, D_{des} is a maximum allowable value of an average time taken for the respective symbols to be transmitted from the data transmitting apparatus to the data receiving apparatus, d is the delay time between the data transmitting apparatus and the data receiving apparatus, and I is a transmission period of the control message.

26. The method of claim 24, wherein the loss rate is calculated using the following equation:
Loss rate=1−(number of received symbols/number of transmitted symbols).

27. The method of claim 24, wherein the code rate is calculated using the following equation:
$${P}_{Rdes} \geq \frac{{P}_{L} - 1 + \sqrt{{( 1 - {P}_{L} )}^{2} - 4 {CP}_{L} ( {( 1 - {P}_{L} )}^{\frac{C}{1 - C}} - 1 )}}{2}$$
where P_{Rdes} is the retransmission request rate, P_{L} is the loss rate, and C is the code rate.
